(19) United States
(12) Patent Application Publication
(10) Pub. No.: US 2016/0352680 A1
(43) Pub. Date: Dec. 1, 2016

(54) METHOD AND SYSTEM FOR INTEGRATING DNS LIST FEEDS

(71) Applicant: BLUECAT NETWORKS, INC., Toronto (CA)

(72) Inventors: Osama Elsharif, Toronto (CA); Richard N. Hyatt, Markham (CA)

(21) Appl. No.: 15/166,115

(22) Filed: May 26, 2016

Related U.S. Application Data
(60) Provisional application No. 62/166,960, filed on May 27, 2015.

(51) Int. Cl. H04L 29/12; H04L 12/26

(52) U.S. Cl. CPC H04L 61/1552; H04L 61/1511; H04L 43/02

(57) ABSTRACT

Methods and systems are disclosed for aggregating and distributing DNS blocked list data feeds to a plurality of geographically distributed network-connected DNS servers.

### CROSS-REFERENCE TO RELATED APPLICATIONS

The present application claims priority to U.S. Provisional Application No. 62/166,960 filed May 27, 2015, titled “METHOD AND SYSTEM FOR INTEGRATING DNS LIST FEEDS,” which is hereby incorporated by reference in its entirety.

### FIELD OF THE INVENTION

This invention is related to secure network computing and more specifically to the detection and prevention of threats using DNS list feeds.

### BACKGROUND OF THE INVENTION

DNS servers serving computing hosts may use Domain Blocked Lists to prevent access to questionable DNS domains by computing hosts, as described in: Taking Back the DNS with Response Policy Zones, Paul Vixie, ISC, July 2010 http://conference.hackinthebox.org/hitbsecconf2010kul/materials/KEYNOTE%202%20-%20Paul %20Vixie%20-%20Taking%20Back%20The%20DNS.pdf. There are a number of providers of Domain Blocked Lists, such as Spamhaus (spamhaus.org) and SURBL (surbl.org). These lists may be distributed to DNS server datafeed clients by the Blocked List datafeed services using transfer protocols, for example the DNS zone transfer protocols as in Incremental Zone Transfer in DNS, M. Ohta, August 1996, IETF, as located at https://tools.ietf.org/html/rfc1995 and DNS Zone Transfer Protocol (AXFR), E. Lewis, June 2010, IETF, as located at https://tools.ietf.org/html/rfc5936. DNS operators may also create their own Domain Blocked Lists based on known bad DNS domains and distribute these lists using the transfer protocols. Within a datafeed there can be categories of domains that are arranged in zones that datafeed clients can select. In some instances, these datafeed clients can be DNS servers.

It is often useful for datafeed clients to use a plurality of datafeeds in order to achieve a more comprehensive list of blocked domains because of the dynamic nature of Internet domains. Due to Internet traffic and the relative geographic locations of the datafeed providers and the DNS servers, the time taken to distribute the plurality of datafeeds to all the DNS servers requiring them may be significant. Therefore, DNS servers may not have consistent or the most updated Blocked Lists.

There are also a number of technical obstacles that may cause additional issues, including but not limited to: 1) access to commercial Domain Blocked Lists may be restricted to registered clients, therefore a mechanism for licensing and managing access across all the datafeeds may be required; 2) datafeed clients may be globally distributed, thus requiring performance optimization for datafeed access based on geographic location; 3) datafeed categories and datafeed providers may change periodically, requiring that the datafeed clients are able to continue operations before during and after such changes; 4) datafeeds may contain overlapping entries that need to be consolidated to prevent unnecessary costs including excessive storage use and processing demands; and others.

Therefore, a need exists for methods and systems that are able to aggregate, distribute and manage Domain Blocked Lists across a global network.

### SUMMARY

Provided herein are embodiments of methods and systems for aggregating and distributing DNS blocked list data feeds to a plurality of geographically distributed DNS servers. The configuration of these methods and systems is described in detail by way of various embodiments which are only examples.

Various aspects illustrated in the embodiments disclosed herein include: 1) datafeeds from one or more datafeed providers can be normalized, for example by aggregating, mapping and grouping into curated categories of DNS zones such as ‘gaming’, ‘malware’, spammers' and others; 2) normalized categories of DNS zones can be provided for transfer from system operators to customer DNS servers at a plurality of regional DNS zone master servers; 3) each distributed DNS server from a plurality of DNS servers may receive a time-limited license that permits it to receive one or more categories from a plurality of aggregated DNS zone data categories; 4) each distributed DNS server may receive these DNS zones by means of DNS zone transfers on a per-category basis from an optimized regional DNS zone master server, as allowed by the time-limited license; 5) each distributed DNS server may limit responses from DNS query request originators that match category zone domain items in at least one of the DNS zones; 6) each distributed DNS server may record DNS query requests that match category zone domain items in at least one of said DNS zones for future reporting and analysis; and others.

Other systems, devices, methods, features and advantages of the subject matter described herein will be or will become apparent to one with skill in the art upon examination of the following figures and detailed description. It is intended that all such additional devices, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE DRAWINGS

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

Illustrated in the accompanying drawing(s) is at least one of the best mode embodiments of the present invention. In such drawing(s):

FIG. 1 is an example embodiment of a generalized network architecture diagram.

FIG. 2 is an example embodiment of a license manager components diagram.

FIG. 3 is an example embodiment diagram of Subscription, Class and License Data Structures.

FIG. 4 is an example embodiment of a zone re-writer diagram.

FIG. 5 is an example embodiment of an end-point device components diagram.

FIG. 6 is an example embodiment of a DNS server components diagram.

FIG. 7 is an example embodiment of a RPZ Activity Report.

### DETAILED DESCRIPTION

Before the present subject matter is described in detail, it is to be understood that this disclosure is not limited to the particular embodiments described, as such may vary. It is also to be understood that the terminology used herein is for the purpose of describing particular embodiments only, and is not intended to be limiting, since the scope of the present disclosure will be limited only by the appended claims.

Provided herein are methods and systems for aggregating and distributing data feeds detailing DNS blocked lists to a plurality of geographically distributed DNS servers.

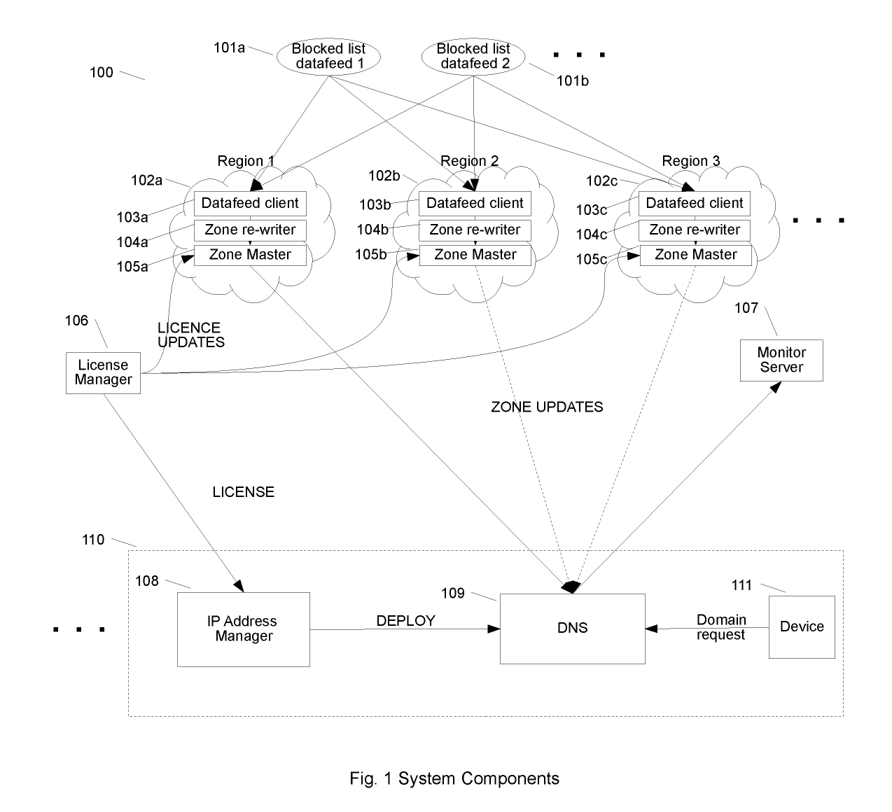

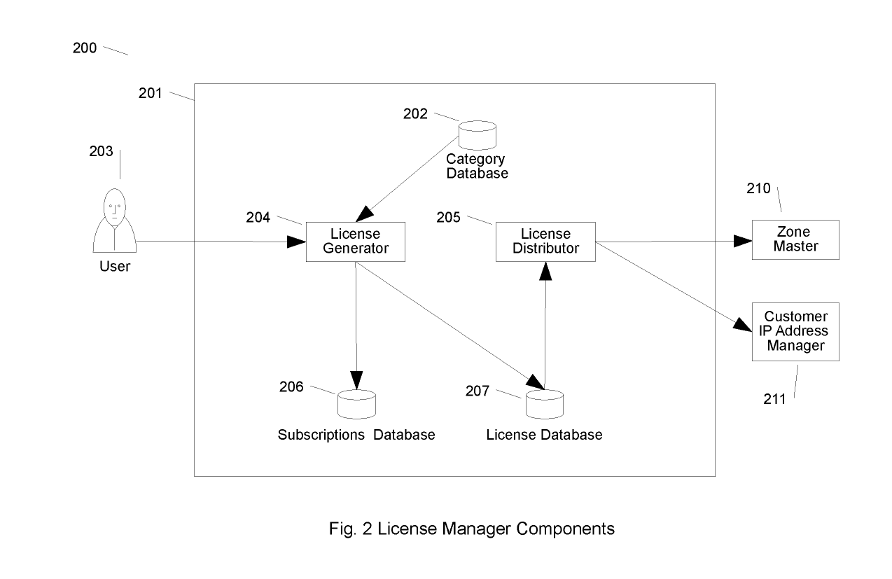

FIG. 1 is an example embodiment of a generalized network architecture diagram 100. In the example embodiment various components and entities are shown, including: a license manager 106 (described further with respect to FIG. 2) communicatively coupled with an IP Address manager 108 and various Zone Masters 105a, 105b and 105c. A plurality of blocked list datafeed services 101a and 101b communicatively coupled with datafeed clients hosted on a plurality of regional DNS zone master servers 105a, 105b and 105c located in computer networking clouds “Region 1” 102a, “Region 2” 102b and “Region 3” 102c, respectively. A plurality of zone re-writer components 104a, 104b and 104c associated with each respective datafeed client component, which can be hardware, software, or a combination thereof. One or more of a plurality of customer systems 110 can be communicatively coupled with Zone Master servers 105a, 105b and 105c. Each customer system 110 can include an IP Address Manager system 108, one or more customer DNS servers 109 that can be communicatively coupled to a monitoring server 107 for analyzing and reporting DNS blocked list behavior, one or more customer devices 111 and others. In some embodiments, an Exception list (not shown) can be maintained that contains domains that are allowed to override one or more entries in Blocked Lists.

In the example embodiment, blocked list datafeeds 101a, 101b can be sent to networking clouds “Region 1” 102a, “Region 2” 102b and “Region 3” 102c, for example using the DNS zone transfer protocol, as previously discussed. Similarly, a license manager 106 can send license updates to networking clouds “Region 1” 102a, “Region 2” 102b and “Region 3” 102c, which they can then be used in order to provision security parameters, for example TSIG keys and expiry dates, to enable zone transfer updates to DNS server 109. License manager 106 can also transmit license updates to IP address manager 108 which can then deploy them to DNS server 109 to provision the security parameters to enable the DNS server 109 to perform zone transfer updates from the regional zone masters 105a, 105b and 105c. Each of these actions can be monitored by one or more monitoring servers 107.

Providing Licenses to the Customers

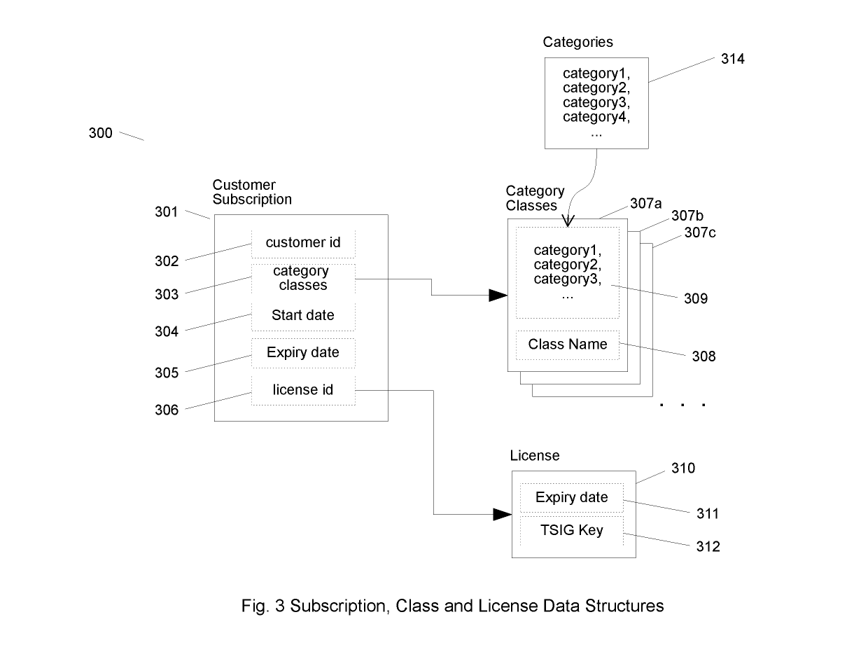

FIG. 2 is an example embodiment of a license manager components diagram 200. As shown in the example embodiment, a license manager 201 can include a license generator 204, a license distributor 205, a license database 207, a subscription database 206 and a category database 202. Licenses for a customer IP Address Management system can be generated by a license manager 201, where license manager 201 may be accessed and interacted with by an administrator user 203 of the customer IP Address Manager by means of a web page or portal using a user interface device (not shown) such as a laptop computer, desktop computer, smartphone or other device as known in the art and having memory, processors and a display, via a communicatively coupled network such as the Internet (not shown) in order to select curated categories to be used, accessed or otherwise managed by the customer's DNS servers. Categories will be further described with respect to FIG. 3.

Upon selection of one or more curated category classes by the administrator user 203, license generator 204 can produce a license and a customer subscription for the customer, including, but not limited to, a customer identifier and an association with the license as will also be further discussed with respect to FIG. 3. Licenses can then be stored in a logical fashion in the license database 207 while subscriptions can be stored in subscription database 206. Licenses can include individual Transaction Signature (TSIG) keys that can be added to a list of TSIG keys for all customers for each category zone, and the list may be stored in the license database 207. License distributor 205 can then initiate updates of regional zone master 210 (e.g., see 105a, 105b, 105c of FIG. 1) whenever a significant change to a license occurs. In some embodiments zone masters 210 can actively poll for license updates, particularly when a license is close to expiring. License distributor 205 can also initiate updates of Customer IP Address Manager 211.

FIG. 3 is an example embodiment diagram 300 of Subscription, Class and License Data Structures. As shown in the example embodiment, a customer subscription 301 can include a customer identifier 302, one or more category classes 303, a start date 304, an expiry date 305, and a license identifier 306.

Category classes 303 can include information from category classes 307a, 307b, 307c and so on, such as class name 308 and category lists 309. In various embodiments, one or more curated categories 314 can be grouped into category classes 307a, 307b, 307c and so on, whereby customer administrator user (e.g. 203 in FIG. 2) can subscribe to one or more classes 307a, 307b, 307c and so on to gain access to the categories contained therein. Classes 307a, 307b, 307c and so on can contain lists 309 of their respective associated categories available to the administrator user (e.g., see 203 of FIG. 2) for selection. This can be determined from the output of the associated zone rewriter (e.g., see 104a, 104b, 104c of FIG. 1) of blocked list datafeeds (e.g., see: 101a, 101b of FIG. 1) and these classes 307a, 307b, 307c and so on can be stored in a categories database (e.g., see 202 of FIG. 2) of a license manager (e.g., see 201 of FIG. 2), for convenient retrieval.

Start date 304 can indicate a date when a subscription begins and can reference the category class 303. Expiry date 305 can indicate a date when a subscription to an associated category zone is no longer valid. License identifier 306 can identify a license 310 including an expiry date 311 which may be the same as, or before, the expiry date 305, and a Transaction Signature key 312. Regional Zone Masters (e.g., see 105a, 105b, 105c of FIG. 1; 210 of FIG. 2) may receive the lists of TSIG keys from the license distributor or manager (e.g., see 106 of FIG. 1, 200 of FIG. 2) for all of the category zones, which may be used to configure the Regional Zone Masters for DNS zone transfers.

Retrieving Datafeeds

Turning back to FIG. 1, in an example embodiment, zone masters 105a, 105b, 105c can receive updates regarding one or more blocked list datafeed services 101a, 101b by periodically polling for updates when the zone masters have registered datafeed clients 103a, 103b, 103c located in their respective network or Internet ‘cloud’ for each respective “Region 1” 102a, “Region 2” 102b and “Region 3” 102c. These registered datafeed clients can be established to serve respective, registered customers of the service, having licenses granted from License Manager 106. As such, when there are updates to blocked list datafeeds 101a, 101b, they can be downloaded to the zone master's respective datafeed client 103a, 103b 103c using a DNS zone transfer protocol.

Creating DNS Zones for Download

A system administrator can register datafeed clients 103a, 103b, 103c for one or more datafeed zone categories to be downloaded, determine the categories to be curated, assign categories into classes and store the curated categories and classes in a category database.

When zones are downloaded by registered datafeed clients 103a, 103b, 103c from blocked list datafeed services 101a, 101b, a zone entry domain contained within each zone can have a particular format, such as:

<blocked domain>.<category>.<blockedlist provider>

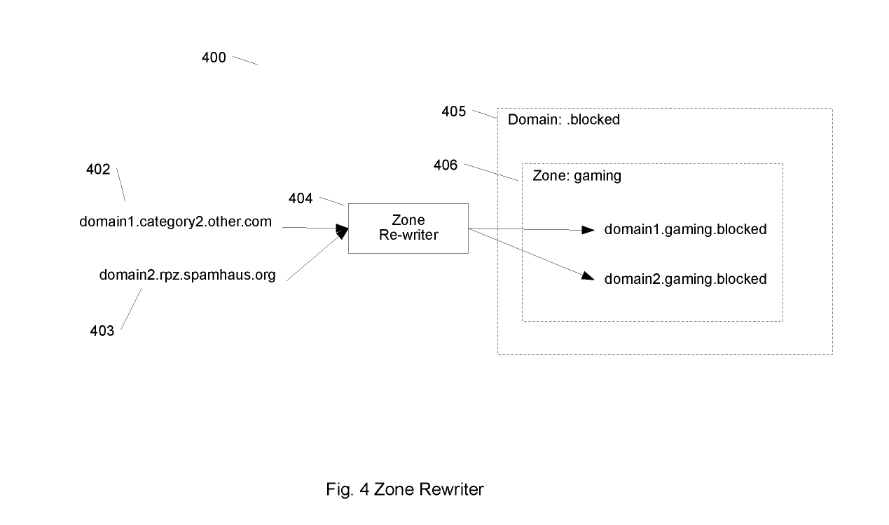

FIG. 4 is an example embodiment of a zone re-writer diagram 400. In the example embodiment, zone entry domains 402 and 403 can be normalized using normalization functions by a zone re-writer 404. As such, they can be mapped into the curated category zones that can be used by DNS servers. Normalization functions of the zone re-writer 104 can be executed by a processor of zone re-writer 104 and can function by consolidating datafeeds from different blocklist providers into one or more parent domains 405 and category zones of blocked domains associated therewith, for example category zone 406. As such, blocked domains such as 402, 403 may be mapped first to the parent domain 405 and then consolidated under different category zones 406, such as ‘gaming,’ before being transferred to regional zone master servers (e.g., see 105a, 105b, 105c of FIG. 1). Duplicate entries can also be consolidated into one entry.

Distributing Blocked Lists to DNS Servers

Turning back to FIG. 1, in an example embodiment, when a customer DNS server 109 is set up, it can be provisioned with a list of Zone Masters 105a, 105b, 105c and a TSIG key from a customer license granted by a license manager 106. These can be used during DNS zone transfers from Zone Masters 105a, 105b, 105c located in their respective Internet ‘cloud’ regions: “Region 1” 102a, “Region 2” 102b and “Region 3” 102c. Optimal Zone Master distribution can be achieved by using a geo-DNS service. For example, Amazon's Geo Routing feature may provide for the nearest geographically located zone delivery based on physical locations where requests originate, as described in: Amazon Route 53: Developer Guide, March 2015 http://awsdocs.s3.amazonaws.com/Route53/latest/route53-dg.pdf. Once the DNS Server 109 has downloaded the Blocked Zone information, it can use it to deny access to the contained domains.

Providing Reports

When a DNS server 109 detects a request for a domain that is on one of the blocked lists by a device 111 from one or more of a plurality of devices such as device 111, the request can be rejected by either returning a ‘not found’ DNS response (NXDOMAIN) or a different, safe response. Additionally, the request from the device or devices may be captured and recorded. This can include capturing the IP address of the host device making the request, the domain requested and the category zone of the requested domain, at or soon after the time the request is made. These can be saved in non-transitory, non-volatile computer readable media for later analysis or transfer to another system or device for processing. Such analysis and feedback can be used to measure a level of success of the domain access protection for particular domains and curated categories, as well as for system optimization by improving Blocked lists. Examples of reports that can be generated using this feedback can indicate one or more of: 1) which IP Addresses associated with devices, such as device 111, are most active in requesting blocked domains; 2) which blocked domains are most frequently requested; 3) which categories are actively being requested; and 4) others.

Feedback reports can also be analyzed with respect to the DNS servers 109 interactively by administrators or using automated software as executed by a processor to provide insight into: 1) identifying which domains are being correctly blocked, indicating that the system is working to prevent access to questionable domains; 2) identifying which domains are being blocked inadvertently, causing an inability to reach the affected legitimate sites and by users, therefore eliciting complaints and indicating that they should be added to an Exception list to permit them to be accessed, if such functionality is enabled; 3) identifying which domains are most active and trending, indicating potential computer infections; 4) identifying or predicting which host devices may be compromised with a computer virus or similar attack by detecting attempts to access blocked domains known to be associated with malware; 5) identifying or predicting which host devices may be vulnerable to attack by detecting attempts to access blocked domains known to be associated with malware; 6) identifying which host devices may be misused; and 7) others.

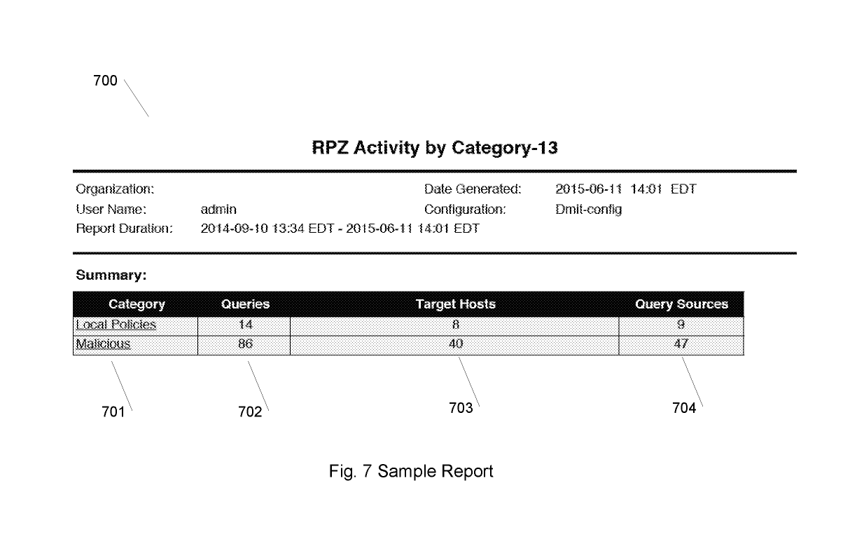

FIG. 7 is an example embodiment of a RPZ Activity Report 700. In some embodiments, reports can be automatically generated and provided for administrative use on a periodic basis and on-demand in human-readable formats, for example as HTML documents, PDF documents available for download and others. As shown in the example embodiment, RPZ Activity Report 700 shows a listing of categories accessed in column 701, a listing of the number of queries for each associated category in column 702, the number of target host domains referenced for each category in column 703 and the number of query source devices for each category in column 704.

In some embodiments these reports can be compiled in structured data formats, such as xml, JSON or others and can be transferred to or otherwise accessed by a monitoring server (e.g., see 107 of FIG. 1) for further analysis.

Turning back to FIG. 1, the monitoring server 107 can receive the reports from one or more of a plurality of DNS servers, such as DNS server 109, and consolidate data from the reports into one or more master reports before processing it to derive aggregated report information. Examples of this information can include: 1) identifying which questionable domains are being attacked locally and which are being attacked globally; 2) identifying which DNS servers are under attack; 3) predicting which DNS servers may be under attack next; 4) identifying which DNS servers are not adequately protected from DNS attacks; and 5) others.

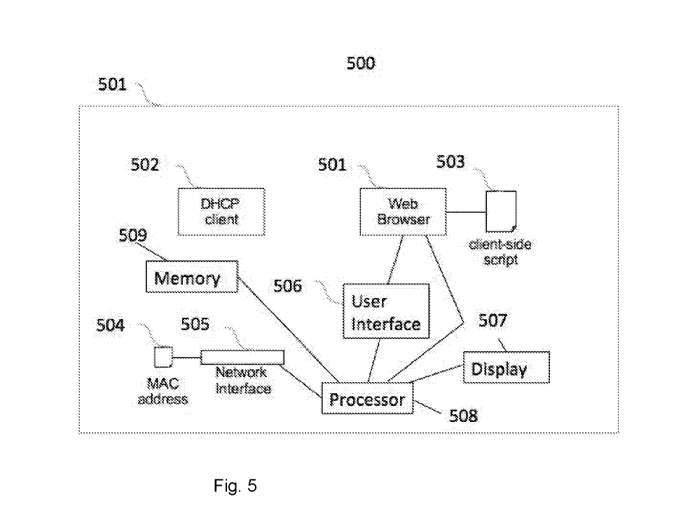

FIG. 5 is an example embodiment of components of an end-point device 500. In the example embodiment, endpoint device 500 can be a computer such as a laptop or desktop, smartphone, video game console, PDA, or various others. Endpoint device 500 (e.g., see end-point device 111 of FIG. 1) can include a DHCP client 501, a Web Browser 502 plugin components, client-side scripts 503, MAC address 504, network interface 505, User interface 506, Display 507, processor 508, non-transitory memory 509 and various other components and elements such as power couplings, operating systems and others. As is known in the art, these various components and their couplings and operations can be variously configured in software, hardware and combinations thereof to create a functional device that is operable to communicate over a computer network.

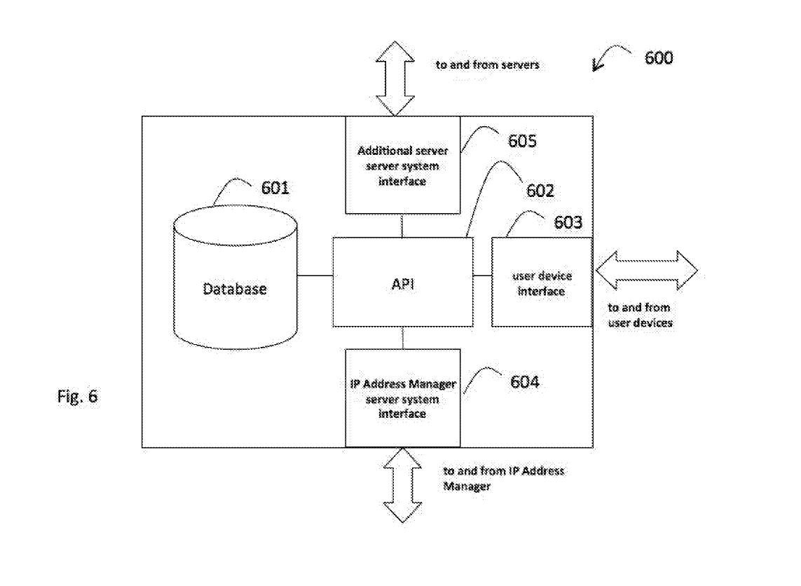

FIG. 6 is an example embodiment of components of a DNS server 600. In the example embodiment, server 600 (see also: DNS server 109 of FIG. 1) includes a database 601 stored in non-transitory computer readable memory, API 602, User device interface 603, IP address manager server system interface 604 and additional server-server system interface 605 which can be managed and function using one or more processors of server 600. These various components can be assembled as is known in the art to create a functional DNS server and can be implemented in software, hardware and combinations thereof as is known in the art.

As used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed. Additionally, all publications discussed herein are hereby incorporated by reference in their entirety.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g. parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

1. A method of distributing DNS Domain blocking lists from a DNS zone master server via a computer network to a plurality of customer DNS servers using an IP address manager computer, comprising:
executing steps stored in non-transitory computer readable media using a processor to cause the IP address manager computer to:
generate a license for a customer;
associate a list of category zones with the license and provide the list of category zones to each of the customer DNS servers;
periodically query at least one blocked list datafeed service and receive a response including blocked list data including zone entry domains;
normalize each zone entry domain into a category zone of a plurality of category zones; and
transfer a selected subset of the normalized category zones to the customer DNS servers according to the customer license.

2. The method of claim 1, wherein a customer subscribes to a class containing category zones according to the customer license.

3. The method of claim 1, wherein at least one normalized category zone is available for transfer to customer DNS servers from a plurality of regional DNS zone master servers

4. The method of claim 1, further comprising:
capturing a request for a domain included in a category zone; and
recording the captured request in non-volatile, non-transitory storage.

5. The method of claim 1, further comprising:
capturing a request for a domain contained within a category zone; and
transferring the captured request to a monitoring server.

6. The method of claim 4, wherein capturing the request further comprises:
capturing the time of the request, the IP address of the host computer making the request, the domain requested and the zone of the blocked domain that corresponds to the category.

7. The method of claim 5 wherein capturing the request further comprises:
capturing the time of the request, the IP address of the host computer making the request, the domain requested and the zone of the blocked domain that corresponds to the category.

8. A system for distributing DNS Domain blocking lists via the Internet, comprising:
a plurality of Internet-connected customer DNS servers;
an Internet-connected license manager computer providing a list of category zones associated with a customer license to each of the customer DNS servers; and
one or more Internet-connected cloud computing DNS zone master servers, wherein a master server includes a processor and steps stored in non-transitory memory that when executed by the processor cause the master server to:
periodically query at least one blocked list datafeed services and receive a plurality of blocked list data containing zone entry domains in response to the queries;
normalize each zone entry domain into a category zone from a plurality of category zones;
transfer a subset of the normalized category zones to a customer DNS server according to the customer license.

9. The system of claim 8, wherein a customer subscribes to a class containing category zones according to the customer license.

10. The system of claim 8, wherein the normalized category zones are available for transfer to customer DNS servers from at least one regional DNS zone master servers.

11. The system of claim 8, further comprising:
the DNS server capturing a request for a domain contained within a category zone; and
recording the captured request in non-transitory non-volatile data storage.

12. The system of claim 8, further comprising:
a monitoring server; and
wherein the DNS server captures a request for a domain contained within a category zone and transfers the captured request to the monitoring server.

13. The system of claim 11, wherein capturing the request further comprises:
capturing at least the time of the request, the IP address of the host computer making the request, the domain requested and the category zone of the requested domain.

14. The system of claim 12, wherein capturing the request further comprises:
capturing at least the time of the request, the IP address of the host computer making the request, the domain requested and the category zone of the requested domain.
